(19) United States
(12) Patent Application Publication
(10) Pub. No.: US 2026/0316504 A1
(43) Pub. Date: Oct. 15, 2026

(54) OFF-ROAD VEHICLE

(71) Applicant: KAWASAKI MOTORS, LTD., Akashi-shi, Hyogo (JP)

(72) Inventors: Takashi HISAMURA, Akashi-shi (JP); Kazuki ISHIBASHI, Akashi-shi (JP)

(73) Assignee: KAWASAKI MOTORS, LTD., Akashi-shi, Hyogo (JP)

(21) Appl. No.: 19/464,653

(22) Filed: Jan. 30, 2026

(30) Foreign Application Priority Data
Mar. 3, 2025 (JP) 2025-033026

(51) Int. Cl. B60G 7/00; B62D 21/02

(52) U.S. Cl. CPC B60G 7/001; B62D 21/02

(57) ABSTRACT

To provide an off-road vehicle capable of suppressing interference between a swing member and a lower frame.

An off-road vehicle includes: a body frame; a wheel that is disposed outside the body frame in a vehicle width direction; and a swing member that has one end mechanically connected to the wheel, extends in the vehicle width direction, and is disposed so as to be vertically swingable with respect to the body frame. The body frame includes a lower frame that is disposed below the swing member while extending in a front-rear direction. An upper surface of an opposing portion of the lower frame opposed to the swing member in an up-down direction is recessed downward as compared with an upper surface of a remaining portion excluding the opposing portion.

### CROSS-REFERENCE TO RELATED APPLICATION

This application claims benefit of priority to Japanese Patent Application No. 2025-033026, filed on Mar. 3, 2025, the entire content of which is incorporated herein by reference.

### TECHNICAL FIELD

The present disclosure relates to an off-road vehicle.

### BACKGROUND ART

JP 2020-55380 A describes a vehicle including a body frame and an arm supported vertically swingably by the body frame.

### SUMMARY

In the vehicle described in JP 2020-55380 A, when the amount of swing of the arm is increased, the arm may interfere with a lower frame.

An object of the present disclosure is to provide an off-road vehicle capable of suppressing interference between a swing member and a lower frame.

One aspect of the present disclosure provides an off-road vehicle including:
a body frame;
a wheel that is disposed outside the body frame in a vehicle width direction; and
a swing member that has one end mechanically connected to the wheel, extends in the vehicle width direction, and is disposed so as to be vertically swingable with respect to the body frame, in which
the body frame includes a lower frame that is disposed below the swing member while extending in a front-rear direction, and
an upper surface of an opposing portion of the lower frame opposed to the swing member in an up-down direction is recessed downward as compared with an upper surface of a remaining portion excluding the opposing portion.

According to the present disclosure, it is possible to provide an off-road vehicle capable of suppressing interference between a swing member and a lower frame.

### BRIEF DESCRIPTION OF DRAWINGS

FIG. 1 is a perspective view of an off-road vehicle according to an embodiment of the present disclosure;

FIG. 2 is a perspective view of a body frame illustrated in FIG. 1;

FIG. 3 is a side view of a left rear wheel illustrated in FIG. 1 as viewed from the inside in a vehicle width direction;

FIG. 4 is a perspective view of an opposing member illustrated in FIG. 3;

FIG. 5 is a cross-sectional view taken along line V-V of FIG. 4;

FIG. 6 is a cross-sectional view taken along line VI-VI of FIG. 3; and

FIG. 7 is a cross-sectional view taken along line VII-VII of FIG. 3.

### DETAILED DESCRIPTION

Hereinafter, an off-road vehicle 1 (which may be hereinafter simply referred to as a vehicle 1) according to an embodiment of the present disclosure will be described with reference to the accompanying drawings. In the following description, a front-rear direction, a left-right direction, and an up-down direction as viewed from a driver may be referred to as a front-rear direction, a left-right direction, and an up-down direction of the vehicle 1 and each component. In the following description, the front-rear direction, the left-right direction, and the up-down direction of the vehicle 1 may be referred to as a vehicle length direction, a vehicle width direction, and a vehicle height direction of the vehicle 1. In the vehicle width direction, a side closer to a center plane of the vehicle 1 may be referred to as an inside in the vehicle width direction, and a side father from the center plane and opposite to the inside in the vehicle width direction may be referred to as an outside in the vehicle width direction.

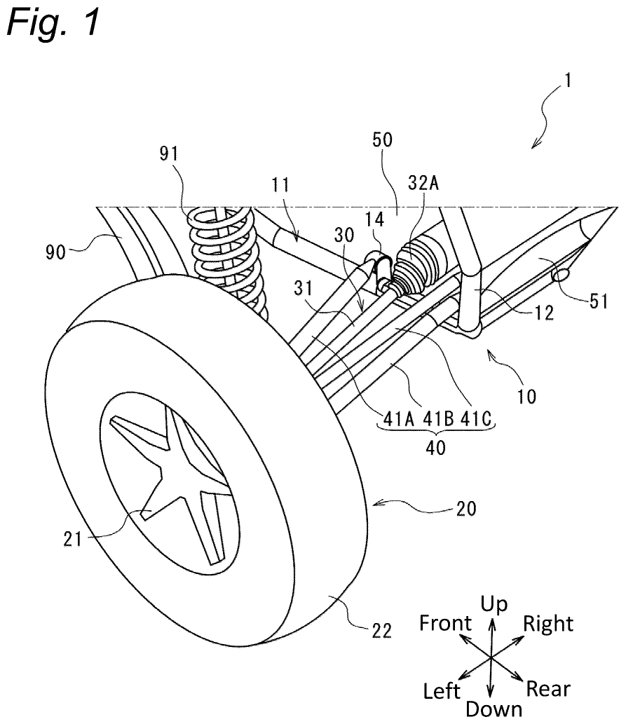

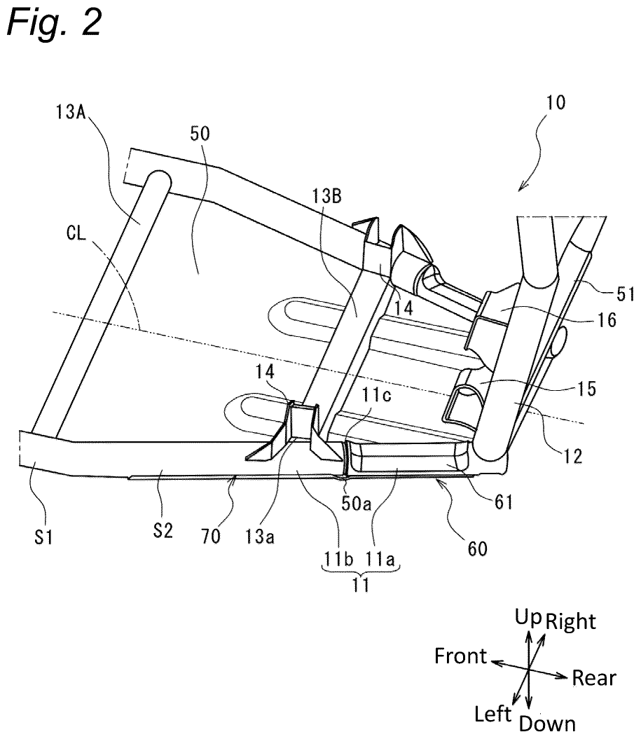

FIG. 1 is a perspective view of a rear portion of the vehicle 1 as viewed from diagonally behind. FIG. 2 is a perspective view of a body frame 10. The vehicle 1 of the present embodiment is an off-road vehicle intended to travel on uneven ground.

The off-road vehicle generally includes a roll-over protection structure (ROPS) and a low-pressure balloon tire. The off-road vehicle preferably has a four-wheel drive function and a differential lock function in order to improve traveling performance on uneven ground. The off-road vehicle is also intended to travel on uneven ground, such as an unpaved road. The road surface to be traveled on is more uneven than a paved road. The uneven ground may include, for example, any one of a rocky ground, a wasteland, a desert, a forest road, and a swamp.

The amount of swing of each wheel of the off-road vehicle in the up-down direction is preferably large. In this case, it is easy to maintain the grounding state of the wheel on an uneven road surface, making it possible to enhance the uneven ground run-through performance. Further, a lower frame supporting the wheel is preferably arranged at a high position with respect to the road surface. This makes it possible to prevent an object protruding upward from the road surface from coming into contact with the lower frame. As a result, it is possible to prevent the object from becoming an obstacle that hinders traveling and to enhance the performance in traveling on uneven ground.

Referring to FIG. 1, the vehicle 1 according to the present embodiment includes a body frame 10 and rear wheels 20. The rear wheels 20 and structures for supporting the rear wheels 20 are provided as left and right pairs. In the following description, the structure on the left side of the vehicle 1 will be described, and the description of the structure on the right side of the vehicle 1 may be omitted. The vehicle 1 includes a drive shaft 30, a link mechanism 40, a cover plate 50, a trading arm 90, and a shock absorber 91.

The body frame 10 constitutes a framework of the vehicle 1. The body frame 10 has sufficient rigidity so as to suppress the amount of deformation with respect to a bending direction load or an axial load generated in the body frame 10 when the vehicle 1 collides with an obstacle or when the vehicle 1 falls. As illustrated in FIG. 2, the body frame 10 includes a pair of left and right lower frames 11 and a pair of left and right vertical frames 12.

Each lower frame 11 constitutes a lower structure of the body frame 10. The lower frame 11 is disposed to extend in the front-rear direction. The pair of left and right lower frames 11 is disposed at intervals in the vehicle width direction. Two cross members 13A, 13B extending in the vehicle width direction are disposed between the pair of left and right lower frames 11. The pair of left and right lower frames 11 is connected by the cross members 13. Specifically, a left end portion of each cross member 13 is connected to the left lower frame 11. A right end portion of each cross member 13 is connected to the right lower frame 11. In the present embodiment, the cross members 13 extend in parallel with the left-right direction.

The pair of left and right lower frames 11 is disposed symmetrically with respect to a center line CL of the vehicle 1 that passes through the center of the vehicle 1 in the vehicle width direction and extends in parallel with the front-rear direction. In the present embodiment, a rear wheel side portion of each lower frame 11 opposed to the rear wheel 20 from the inside in the vehicle width direction extends rearward while inclining inward in the vehicle width direction. A portion of each lower frame 11 located ahead of the rear wheel 20 extends in parallel with the front-rear direction. In other words, each lower frame 11 has a parallel portion S1 extending in parallel with the front-rear direction as extending rearward from its front end, and an inclined portion S2 inclined inward in the vehicle width direction as extending rearward from the rear end of the parallel portion S1.

The two cross members 13A, 13B include the front cross member 13A connecting the parallel portions S1 of the pair of lower frames 11 and a center cross member 13B connecting the inclined portions S2 of the pair of lower frames 11. The cross members 13A, 13B are disposed at intervals in the front-rear direction. Each cross member 13 also functions as a reinforcing member that reinforces each lower frame 11 against deformation thereof.

The front cross member 13A is disposed on the parallel portion S1 of each lower frame 11 at a position adjacent to the inclined portion S2. In the present embodiment, the front cross member 13A is implemented by a columnar pipe member.

The center cross member 13B is disposed on the inclined portion S2 of each lower frame 11 at an intermediate position in the front-rear direction thereof. The center cross member 13B is formed by bending a plate. In the present embodiment, the center cross member 13B is formed in a channel shape protruding upward. The center cross member 13B has a contact portion 13a that is in contact with an upper surface of the lower frame 11 and is joined to the upper surface of the lower frame 11. The center cross member 13B is provided with rod support portions 14 that swingably support an inner end portion in the vehicle width direction of a link rod 41A to be described later.

A cover plate 50 is disposed between the pair of left and right lower frames 11. The cover plate 50 is formed in a plate shape. The cover plate 50 is made of a metal material. The cover plate 50 covers the body frame 10 from below. Specifically, the cover plate 50 covers, from below, a region surrounded by the front cross member 13A and the inclined portion S2 of each lower frame 11. More specifically, the cover plate 50 extends in the front-rear direction from the front cross member 13A to the rear end of the lower frame 11. The cover plate 50 is provided to protect an in-vehicle component disposed above the lower frame 11. The cover plate 50 makes it possible to prevent a protruding object protruding from the ground from coming into contact with the in-vehicle component. The in-vehicle component may be a joint portion of the drive shaft 30 or a part of a transmission for driving the rear wheel 20.

The cross members 13A, 13B are disposed on an upper surface of the cover plate 50. The cover plate 50 is connected, specifically, welded to a lower portion of the inclined portion S2 of each lower frame 11. Besides the inclined portion S2 of the lower frame 11, the cover plate 50 is preferably connected to, specifically welded to, a lower portion of each cross member 13. The cover plate 50 protects body components above the cover plate 50 and also functions as a reinforcing member that reinforces the lower frame 11 against deformation thereof.

The pair of left and right vertical frames 12 constitutes a rear end structure of the body frame 10. Each vertical frame 12 is disposed to extend in the up-down direction. Each vertical frame 12 is joined to the rear end of the corresponding lower frame 11. Specifically, the left vertical frame 12 is connected to an upper portion of the rear end of the left lower frame 11. The right vertical frame 12 is connected to an upper portion of the rear end portion of the right lower frame 11. Each vertical frame 12 extends upward so as to be inclined outward in the vehicle width direction. The pair of left and right vertical frames 12 is disposed symmetrically with respect to the center line CL. Each vertical frame 12 has a hollow structure. Specifically, the vertical frame 12 is a cylindrical pipe frame.

The pair of left and right vertical frames 12 is disposed at intervals in the vehicle width direction. A rear plate 51 is disposed between the pair of left and right vertical frames 12. The pair of left and right vertical frames 12 is connected by the rear plate 51. The rear plate 51 prevents an obstacle from coming into contact with an in-vehicle component located in front of the rear plate 51 from behind. The rear plate 51 is made of a metal material. The rear plate 51 is connected, specifically, welded to an inner portion of each vertical frame 12 in the vehicle width direction. The rear plate 51 may be connected, specifically, welded to an inner portion of the rear end of each lower frame 11 in the vehicle width direction. The rear plate 51 may be connected to the rear end of the cover plate 50 described above. At least a part of the cover plate 50 may also serve as the rear plate 51. At least a part of the rear plate 51 may also serve as the cover plate 50. As described above, the vertical frames 12 and the rear plate 51 are directly or indirectly connected to the lower frames 11 to function as a reinforcing member that reinforces the lower frames 11 against deformation thereof. The rear plate 51 is provided with rod support portions 15, 16 that swingably support inner end portions in the vehicle width direction of link rods 41B, 41C to be described later.

The rear wheels 20 are respectively disposed on both sides of the body frame 10 in the vehicle width direction. Specifically, each rear wheel 20 is disposed outside the inclined portion S2 of the lower frame 11 in the vehicle width direction with an interval from the lower frame 11 in the vehicle width direction. The rear wheel 20 includes a wheel 21 and a tire 22 mounted on the wheel 21. The rear wheel 20 of the present embodiment is an example of a wheel according to the present disclosure.

The wheel 21 is rotatably supported around a rotation axis by a knuckle. The wheel 21 is connected to a rear end portion of the trading arm 90 via the knuckle. The wheel 21 is swingably supported by the body frame 10 via the knuckle and the trading arm 90.

A front end portion of the trading arm 90 is swingably connected to the body frame 10. Specifically, the front end portion of the trading arm 90 is connected to the body frame 10 so as to be angularly displaceable about a pivot axis extending in the vehicle width direction. The trading arm 90 is disposed outside the lower frame 11 in the vehicle width direction. The front end portion of the trading arm 90 is supported by the body frame 10 at a position away forward from the rear wheel 20 in a side view. For example, the front end portion of the trading arm 90 may be located near a rear portion of a seat of the vehicle 1 in the side view. The rear end portion of the trading arm 90 is a free end, and is vertically swingable in a swing region including a region above the lower frame 11 and a region behind the lower frame 11.

The trading arm 90 is connected to a lower end portion of the shock absorber 91 at a position ahead of a support position where the trading arm 90 supports the rear wheel 20. An upper end portion of the shock absorber 91 is connected to a portion of the body frame 10 located above the trading arm 90. Since the shock absorber 91 has a spring property and a damper property, and is configured to extend and contract, it is possible to suppress swinging of the trading arm 90, and inhibit vertical movement of the rear wheel 20 caused along with the unevenness of the road surface from being transmitted to the body frame 10 as a shock.

The knuckle that supports the wheel 21 is supported so that its posture is changeable with respect to a support position set at the rear end portion of the trading arm 90. In addition, since the knuckle is coupled to the body frame 10 by the multiple link rods 41B, 41C arranged vertically with the rotation axis interposed therebetween in addition to the trading arm 90, it is possible to suppress a change in an inclination angle of the rotation axis of the rear wheel with respect to the horizontal direction, that is, a so-called camber angle change. In addition, since the knuckle is coupled to the body frame 10 by the multiple link rods 41A, 41B arranged in the front-rear direction with the rotation axis interposed therebetween in addition to the trading arm 90, it is possible to suppress a change in a swing angle of the rotation axis of the rear wheel around the vertical axis, that is, a so-called toe angle change.

The drive shaft 30 is disposed in a one-to-one correspondence to the rear wheel 20. Each drive shaft 30 extends in the vehicle width direction. The drive shaft 30 is disposed above the lower frame 11 with an interval from the lower frame 11. The drive shaft 30 mechanically connects the rear wheel 20 to a differential mechanism mounted on the body frame 10. The drive shaft 30 is configured to transmit a rotational force from the differential mechanism to the rear wheel 20. The drive shaft 30 includes a shaft body 31 extending in the vehicle width direction, joints disposed at both ends of the shaft body 31 in the vehicle width direction, and covers 32A, 32B covering the joints. In the present embodiment, each joint is implemented by a constant velocity joint.

The inner joint disposed at an inner end portion of the shaft body 31 in the vehicle width direction is mechanically connected to the differential mechanism. The outer joint disposed at an outer end portion of the shaft body 31 in the vehicle width direction is mechanically connected to the wheel 21 of the rear wheel 20. In this manner, the joints are disposed at both ends of the shaft body 31. The joint is configured to maintain the transmission state of rotational power from a shaft on the input side to a shaft on the output side even when an angle between the shaft on the input side and the shaft on the output side changes at the connection portion. In other words, since the joint is interposed between the shaft on the input side and the shaft on the output side, even if the rear wheel 20 moves up and down with respect to the body frame 10, power from a drive source can be transmitted to the rear wheel 20 to rotate the rear wheel 20.

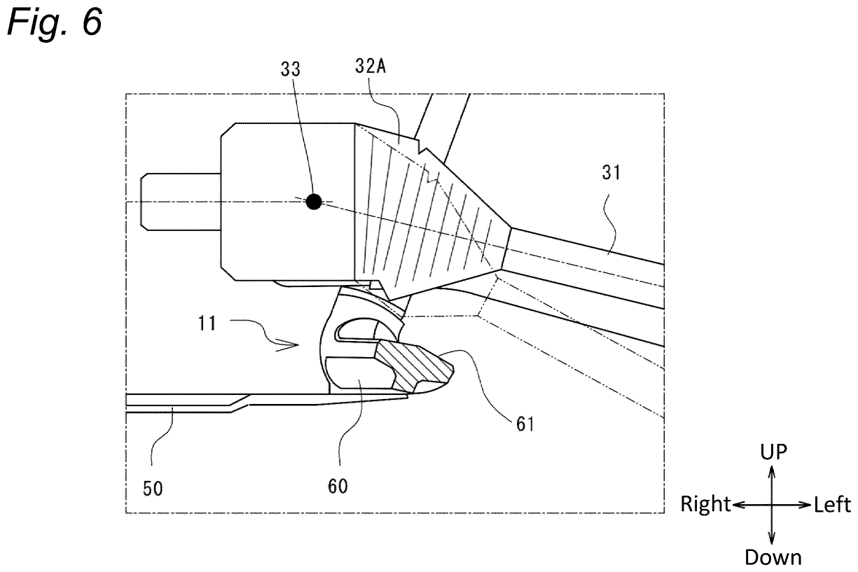

The drive shaft 30 is disposed to be vertically swingable with respect to the body frame 10. Specifically, the shaft body 31 can be angularly displaced by the inner joint about an inner pivot axis 33 (illustrated in FIG. 6) which is set inside the lower frame 11 in the vehicle width direction and extends in the front-rear direction. In addition, the shaft body 31 can be angularly displaced by the outer joint around an outer pivot axis which is set on the knuckle and extends in the front-rear direction. As a result, it is possible to apply a driving force to the vertically moving rear wheel 20 in a state where the rotation axis of the rear wheel 20 is maintained substantially horizontal. As described above, the shaft body 31 swings with respect to the body frame 10 about the inner pivot axis 33 as the rear wheel 20 moves up and down. Accordingly, the shaft body 31 according to the present embodiment is an example of a swing member according to the present disclosure.

The shaft body 31 is located in a space above the inclined portion S2 of the lower frame 11. The shaft body 31 overlaps the lower frame 11 in a top view, and extends from the inside in the vehicle width direction to the outside in the vehicle width direction of the inclined portion S2 of the lower frame 11. Accordingly, when the rear wheel 20 moves downward with respect to the body frame 10, the vertical distance between the shaft body 31 and a portion of the lower frame 11 located immediately below the shaft body 31 decreases.

The covers 32A, 32B prevent a foreign matter such as sand or mud from entering the respective joints by covering the joints. The covers 32A, 32B are formed in a tubular shape and cover the joints and a part of the shaft body 31. The covers 32A, 32B are provided in the respective joints, and include an inner cover 32A covering the inner joint and an outer cover 32B covering the outer joint. The covers 32A, 32B are configured to be deformable. Portions of the covers 32A, 32B that cover the shaft body 31 are deformed along with displacement of the shaft body 31, so that a gap between the covers 32A, 32B and the shaft body 31 can be kept small. In the present embodiment, the covers 32A, 32B are implemented as bellows-shaped cylindrical bodies, and an opening on the shaft body 31 side is formed smaller than an opening on the joint side.

The inner cover 32A according to the present embodiment is an example of a swing member according to the present disclosure. The inner cover 32A is located in a space above the inclined portion S2 of the lower frame 11. Depending on a situation where the rear wheel 20 swings, the inner cover 32A may overlap the lower frame 11 in a top view and extend from the inside in the vehicle width direction to the outside in the vehicle width direction of the inclined portion S2 of the lower frame 11. Accordingly, when the rear wheel 20 moves downward with respect to the body frame 10, the vertical distance between the inner cover 32A and the portion of the lower frame 11 located immediately below the inner cover becomes small.

The link mechanism 40 is disposed in a one-to-one correspondence to the rear wheel 20. Each link mechanism 40 couples the rear wheel 20 to the body frame 10 so as to be vertically swingable with respect to the body frame 10. Each link mechanism 40 couples the knuckle and the body frame 10. Each link mechanism 40 is implemented by including three link rods 41A to 41C. In the following description, when it is not necessary to particularly distinguish the three link rods 41A to 41C from one another, one of the three link rods 41A to 41C may be simply referred to as a link rod 41. The link rod 41 is disposed around the drive shaft 30 and extends in the vehicle width direction. The link rod 41 links the knuckle and the body frame 10. As a result, the knuckle is kept swingable with respect to the body frame 10. In other words, the link mechanism 40 allows relative movement of the rear wheel 20 in the up-down direction with respect to the body frame 10 while suppressing a posture change of the rear wheel 20 with respect to the body frame 10.

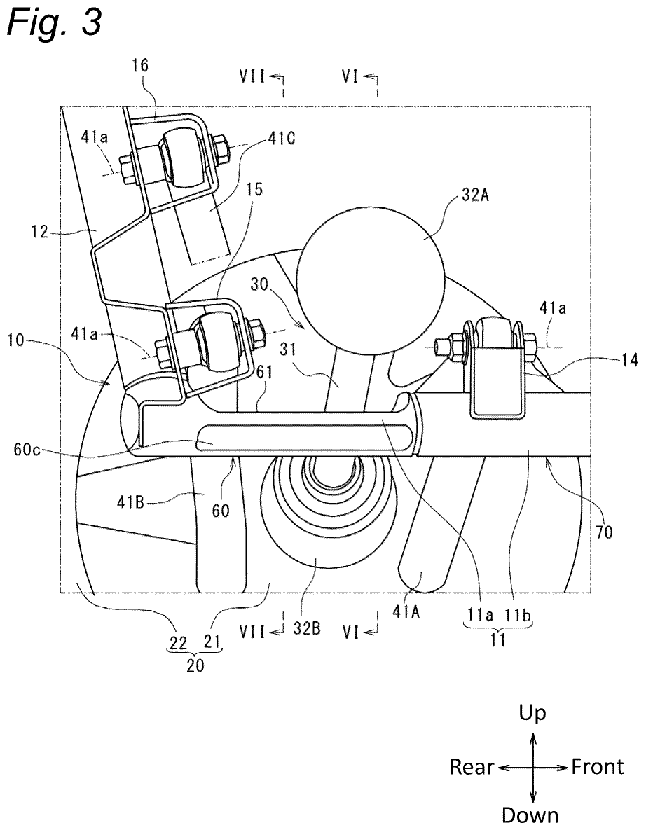

The link rod 41 extends in the vehicle width direction. An inner end portion of the link rod 41 in the vehicle width direction is linked to the body frame 10. The link rod 41 is coupled to the body frame 10 so as to be angularly displaceable about a front-rear axis 41a (illustrated in FIG. 3) as a pivot axis extending in the front-rear direction. An outer end portion of the link rod 41 in the vehicle width direction is linked to the knuckle. The link rod 41 is coupled to the knuckle so as to be angularly displaceable about the front-rear axis extending in the front-rear direction. The link rod 41 is connected to the body frame 10 and the knuckle via ball joints provided at both ends. As a result, the link rod 41 is allowed to swing within a predetermined range other than around the front-rear axis along with the vertical movement of the rear wheel 20.

The inner end portion of the link rod 41 in the vehicle width direction is located in a space located above the inclined portion S2 of the lower frame 11. The link rod 41 overlaps the lower frame 11 in a top view, and extends from the inside in the vehicle width direction to the outside in the vehicle width direction of the inclined portion S2 of the lower frame 11. Accordingly, when the rear wheel 20 moves downward with respect to the body frame 10, the vertical distance between the link rod 41 and the portion of the lower frame 11 located immediately below the link rod becomes small.

The link rod 41A is disposed in front of the shaft body 31. The inner end portion of the link rod 41A in the vehicle width direction is attached to the rod support portion 14 fixed to the lower frame 11 and the center cross member 13B. As illustrated in FIG. 2, in the present embodiment, the rod support portion 14 is located above the contact portion 13a of the center cross member 13B that is in contact with the lower frame 11. The rod support portion 14 is formed integrally with the center cross member 13B. For example, the rod support portion 14 may be welded to the lower frame 11 and the center cross member 13B.

The rod support portion 14 is disposed immediately above the contact portion 13a. In other words, the rod support portion 14 is disposed at a position overlapping the lower frame 11 and the center cross member 13B in a top view. As described above, the inner end portion of the link rod 41A in the vehicle width direction is disposed at a position spaced upward from the upper end of the lower frame 11.

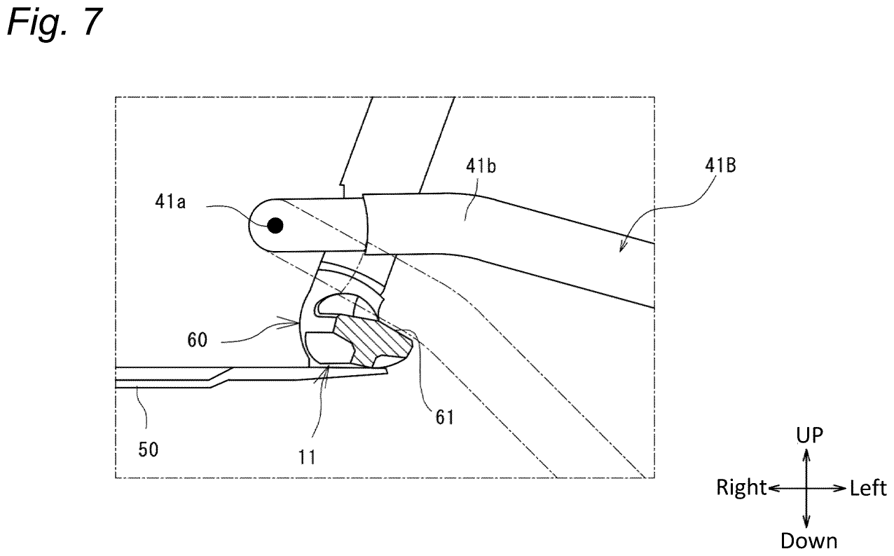

The link rod 41B is disposed behind and below the shaft body 31. An inner end portion of the link rod 41B in the vehicle width direction is attached to the rod support portion 15 fixed to the rear plate 51. The inner end portion of the link rod 41B in the vehicle width direction is located in front of the vertical frame 12. The inner end portion of the link rod 41B in the vehicle width direction is located inside the lower frame 11 and the vertical frame 12 in the vehicle width direction. The link rod 41B is convexly curved upward at a position opposed to the lower frame 11 in the circumferential direction about the front-rear axis 41a. In other words, the link rod 41B has a curved portion 41b (illustrated in FIG. 7) disposed at a position opposed to the lower frame 11 in the circumferential direction about the front-rear axis 41a (illustrated in FIG. 3). The link rod 41B according to the present embodiment is an example of a swing member according to the present disclosure.

The link rod 41C is disposed behind and above the shaft body 31. The link rod 41C is disposed above the link rod 41B. An inner end portion of the link rod 41C in the vehicle width direction is attached to the rod support portion 16 fixed to the rear plate 51. The inner end portion of the link rod 41C in the vehicle width direction is located in front of the vertical frame 12. The inner end portion of the link rod 41C in the vehicle width direction is located inside the lower frame 11 and the vertical frame 12 in the vehicle width direction.

The two link rods 41B, 41C arranged in the up-down direction with the drive shaft 30 interposed therebetween link the knuckle and the body frame 10. In this manner, the posture change of the rear wheel 20 is restricted by the two link rods 41B, 41C arranged vertically, making the rear wheel 20 easy to translate in the up-down direction according to the vertical movement of the rear wheel 20. In other words, it is possible to suppress a change in the camber angle of the rear wheel 20 caused by the vertical movement of the rear wheel 20.

The two link rods 41A, 41B arranged in the front-rear direction with the drive shaft 30 interposed therebetween link the knuckle and the body frame 10. In this manner, the posture change of the rear wheel 20 is restricted by the two link rods 41A, 41B arranged in the front-rear direction, making the rear wheel 20 easy to translate in the front-rear direction according to the vertical movement of the rear wheel 20. In other words, a change in the toe angle of the rear wheel 20 caused by the vertical movement of the rear wheel 20 can be suppressed.

FIG. 3 is a side view of the left rear wheel 20 of the present embodiment as viewed from the inside in a vehicle width direction. The lower frame 11 includes an opposing portion 11a that is vertically opposed to the swing member extending in the vehicle width direction and swinging in accordance with the vertical movement of the rear wheel 20, and a remaining portion 11b that is a portion of the lower frame 11 excluding the opposing portion 11a. In the present embodiment, the shaft body 31, the inner cover 32A, and the link rod 41B correspond to the swing members. Each of the opposing portion 11a and the remaining portion 11b is formed in a rear wheel side portion, which is opposed to the rear wheel 20 from the inside in the vehicle width direction, of the lower frame 11. The opposing portion 11a is a rear side portion of the rear wheel side portion, and the remaining portion 11b is a front side portion of the rear wheel side portion. In other words, each of the opposing portion 11a and the remaining portion 11b is formed in the inclined portion S2, which is inclined inward in the vehicle width direction as the lower frame 11 extends rearward, of the lower frame 11. The opposing portion 11a is a rear side portion of the inclined portion S2, and the remaining portion 11b is a front side portion of the inclined portion S2. As described above, in the present embodiment, the opposing portion 11a is disposed behind the remaining portion 11b. An upper surface of the opposing portion 11a is recessed downward as compared with an upper surface of the remaining portion 11b. A lower surface of the opposing portion 11a extends along a lower surface of the remaining portion 11b. In the present embodiment, the lower surface of the opposing portion 11a and the lower surface of the remaining portion 11b extend substantially horizontally and are aligned in the up-down direction.

In the present embodiment, the lower frame 11 has a divided structure including multiple members including an opposing member 60 constituting the opposing portion 11a and a remaining member 70 constituting the remaining portion 11b. The lower frame 11 is assembled by connecting a front end portion of the opposing member 60 and a rear end portion of the remaining member 70 to each other. The lower frame 11 and the vertical frame 12 are connected to each other by connecting an upper portion of the rear end of the opposing member 60 and a lower end portion of the vertical frame 12 to each other.

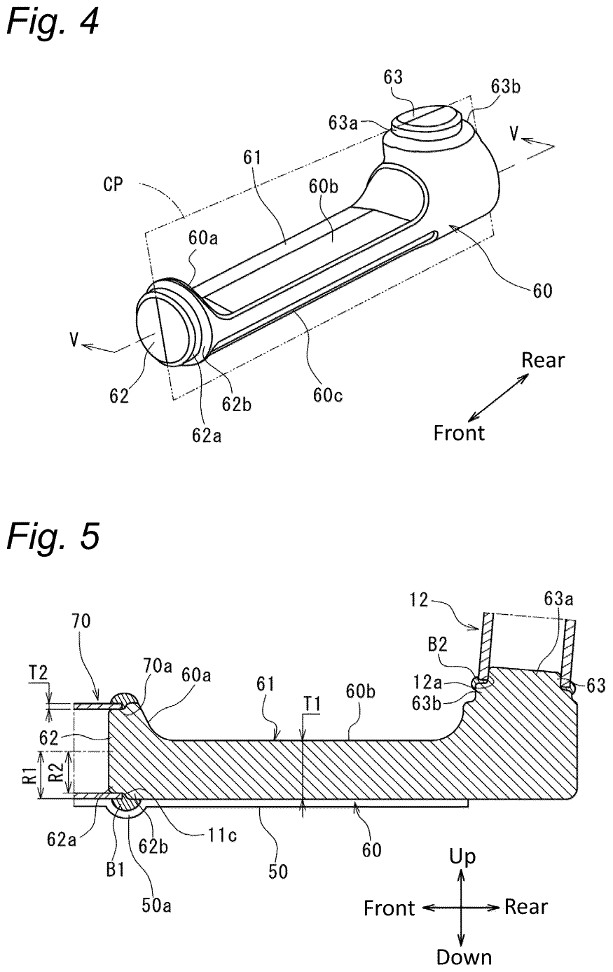

FIG. 4 is a perspective view of the opposing member 60. FIG. 5 is a cross-sectional view taken along line V-V of FIG. 4. In FIG. 5, the remaining member 70, the vertical frame 12, and the cover plate 50 are illustrated together with the opposing member 60. In a state where the opposing member 60 is implemented as the lower frame 11, the upper surface of the opposing member 60 is recessed downward as compared with the upper surface of the remaining member 70. In other words, the upper surface of the opposing member 60 is located below the upper surface of the remaining member 70. More specifically, an upper surface of an intermediate portion of the opposing member 60 excluding both end portions thereof is located below the upper surface of the remaining member 70. An end surface of the opposing member 60 on the remaining member 70 side is located at the same height as the upper surface of the remaining member 70. The opposing member 60 includes an inclined surface 60a extending downward as it extends rearward from the remaining member 70, and a flat surface 60b horizontally extending rearward from the rear end of the inclined surface 60a. By forming the inclined surface 60a, it is possible to prevent an abrupt change in the cross-sectional shape of the opposing member 60 along the front-rear direction, and to prevent a decrease in rigidity.

In the present embodiment, the lower surface of the opposing member 60 extends along the lower surface of the remaining member 70. For example, the lower surface of the opposing member 60 and the lower surface of the remaining member 70 extend horizontally and are aligned in the up-down direction. In the present embodiment, a lightening portion 60c for weight reduction is formed in a lower portion of the opposing member 60. Specifically, the lightening portion 60c is a groove formed in the lower portion of the opposing member 60 and extending in the front-rear direction while being recessed upward. The lightening portion 60c is preferably formed at a position except for both axial end portions and an upper portion of the opposing member 60.

Referring to FIG. 4, the opposing member 60 is a component having a longitudinal direction extending along the front-rear direction. The opposing member 60 is formed symmetrically with respect to a central plane CP including an extension line of the central axis of the remaining member 70 to be connected and extending along the axis of the vertical frame 12. The opposing member 60 has a solid structure. In other words, the opposing member 60 has a massive structure without a cavity. On the other hand, the remaining member 70 has a hollow structure. In other words, the opposing member 60 has a larger density with respect to the outer shape than the remaining member 70, and is formed in a thick shape.

The opposing member 60 is a die-molded component formed by die molding, and is an integral structural component. For example, the opposing member 60 is implemented by a cast component, a forged component, or the like. In the present embodiment, the opposing member 60 is made of a forged component. The opposing member 60 can be molded by two molding dies in which a division plane is located on the central plane CP described above. Since the opposing member 60 is formed by molding, it is easy to implement a structure in which the cross-sectional shape changes as it proceeds in the axial direction. The remaining member 70 is a cylindrical pipe frame extending in the front-rear direction. The remaining member 70 has a uniform cross-sectional shape along the axial direction.

A recessed portion 61 recessed downward is formed in the upper surface of the opposing member 60. The recessed portion 61 includes a surface of the upper surface of opposing member 60, which is located below other portions, i.e., an inclined surface 60a and a flat surface 60b. The recessed portion 61 of the present embodiment is formed over a range opposed to each of the shaft body 31, the inner cover 32 A, and the link rod 41B in the up-down direction. As illustrated in FIG. 5, a thickness dimension T1 of the recessed portion 61 of the opposing member 60 is larger than a thickness dimension T2 of the remaining member 70. In other words, the dimension T1 of the recessed portion 61 in the up-down direction is larger than the difference (R1−R2) between an outer radius R1 and an inner radius R2 of the remaining member 70.

The front end of the opposing member 60 is joined to the rear end of the remaining member 70. The opposing member 60 and the remaining member 70 are each formed in a shape that can be fitted to each other in the axial direction of the lower frame 11. Specifically, a laterally projecting portion 62 is formed at the front end of the opposing member 60. The laterally projecting portion 62 is located in front of the recessed portion 61. The laterally projecting portion 62 has a stepped cylindrical shape protruding forward. The laterally projecting portion 62 has a front end portion 62a having an outer diameter smaller than the inner diameter of the remaining member 70, and a flange portion 62b adjacent to the rear of the front end portion 62a. A flange portion 62b has an outer diameter larger than the inner diameter of the remaining member 70. The laterally projecting portion 62 is disposed coaxially with the remaining member 70 while being fitted to the remaining member 70. The rear end of the remaining member 70 is in contact with the flange portion 62b while being fitted to the laterally projecting portion 62 of the opposing member 60. In a state where the laterally projecting portion 62 and the remaining member 70 are fitted to each other, a boundary portion between the flange portion 62b and the rear end of the remaining member 70 is joined by welding in the circumferential direction. In other words, the opposing member 60 is inserted and welded to the remaining member 70. A weld bead B1 extending in the circumferential direction is formed at a boundary portion between the flange portion 62b and the rear end of the remaining member 70. Since the opposing member 60 is formed by die forming, the fitting shape into which the remaining member 70 is fitted, that is, the laterally projecting portion 62 can be formed simultaneously at the time of die forming, and thus the work of processing the opposing member 60 can be simplified.

The upper portion of the rear end of the opposing member 60 is joined to the lower end of the vertical frame 12. The opposing member 60 and the vertical frame 12 are respectively formed in shapes that can be fitted to each other in the axial direction of the vertical frame 12. To be more specific, the opposing member 60 has a vertically projecting portion 63. The vertically projecting portion 63 is formed in the upper portion of the rear end of the opposing member 60. The vertically projecting portion 63 is located behind the recessed portion 61. The vertically projecting portion 63 has a stepped cylindrical shape protruding upward. The vertically projecting portion 63 has an upper end portion 63a having an outer diameter smaller than the inner diameter of the vertical frame 12 and a flange portion 63b adjacent below the upper end portion 63a. The flange portion 63b has an outer diameter larger than the inner diameter of the vertical frame 12. The vertically projecting portion 63 is disposed coaxially with the vertical frame 12 in a state where the vertical frame 12 is fitted thereto. The lower end of the vertical frame 12 is in contact with the flange portion 63b while being fitted to the vertically projecting portion 63 of the opposing member 60. In this manner, in a state where the vertically projecting portion 63 and the vertical frame 12 are fitted to each other, a boundary portion between the flange portion 63b and the lower end of the vertical frame 12 is joined by welding in the circumferential direction. In other words, the opposing member 60 is inserted and welded to the vertical frame 12. A weld bead B2 extending in the circumferential direction is formed at a boundary portion between the flange portion 63b and the lower end of the vertical frame 12. Since the opposing member 60 is formed by die forming, the fitting shape into which the vertical frame 12 is fitted, that is, the vertically projecting portion 63 can be formed simultaneously at the time of die forming, and thus the work of processing the opposing member 60 can be simplified.

As illustrated in FIG. 5, a joint portion between the opposing member 60 and the remaining member 70 is covered with the cover plate 50 from below. A portion 50a of the cover plate 50 covering a joint portion 11c between the opposing member 60 and the remaining member 70 is recessed downward as compared with a remaining portion 11b. As a result, the cover plate 50 covers the weld bead B1 generated at the joint portion 11c between the opposing member 60 and the remaining member 70 from below. The cover plate 50 is joined to both the opposing member 60 and the remaining member 70 by welding.

FIG. 6 is a cross-sectional view taken along line VI-VI of FIG. 3. In FIG. 6, the shaft body 31 and the inner cover 32A swung downward around the pivot axis 33 are indicated by two-dot chain lines. As illustrated in FIG. 6, the opposing portion 11a of the lower frame 11 is recessed downward, so that interference between the shaft body 31 or the inner cover 32A and the lower frame 11 can be prevented even when the shaft body 31 and the inner cover 32A swing downward around the pivot axis 33.

FIG. 7 is a cross-sectional view taken along line VII-VII of FIG. 3. In FIG. 7, the link rod 41B swung downward about the front-rear axis 41a as a pivot axis is indicated by two-dot chain lines. As illustrated in FIG. 7, the opposing portion 11a of the lower frame 11 is recessed downward, so that interference between the link rod 41B and the lower frame 11 can be prevented even when the link rod 41B swings downward about the front-rear axis 41a.

The vehicle 1 according to the present embodiment has the following effects.

(1) The vehicle 1 according to the present embodiment including:
the body frame 10;
the rear wheel 20 that is disposed outside the body frame 10 in the vehicle width direction; and
the swing member (the shaft body 31, the inner cover 32A, and the link rod 41B in the present embodiment) that has one end mechanically connected to the rear wheel 20, extends in the vehicle width direction, and is disposed so as to be vertically swingable with respect to the body frame 10, in which
the body frame 10 includes a lower frame 11 that is disposed below the swing member while extending in the front-rear direction, and
the upper surface of the opposing portion 11a of the lower frame 11 opposed to the swing member in the up-down direction is recessed downward as compared with the upper surface of the remaining portion 11b excluding the opposing portion 11a.

According to the off-road vehicle 1 of the present embodiment, it is possible to suppress collision between an obstacle located below the vehicle 1 and the lower frame 11 while suppressing interference between the swing member and the lower frame 11. Since the upper surface of the opposing portion 11a is recessed downward, it is possible to suppress contact between the lower frame 11 and the swing member when the swing member swings downward.

(2) In the present embodiment, the lower surface of the opposing portion 11a extends along the lower surface of the remaining portion 11b.

According to the off-road vehicle 1 of the present embodiment, since the lower surface of the opposing portion 11a extends along the lower surface of the remaining portion 11b, that is, does not have a shape protruding downward from the lower surface of the remaining portion 11b, it is possible to inhibit an obstacle protruding from the ground from colliding with the lower surface of the opposing portion 11a.

(3) The thickness dimension T1 of the opposing portion 11a in the up-down direction is larger than the thickness dimension T2 of the remaining portion 11b in the up-down direction.

According to the off-road vehicle 1 of the present embodiment, it is possible to increase strength against bending of each of the opposing portion 11a and the remaining portion 11b, and thus possible to suppress deformation of the lower frame 11. Since the upper surface of the remaining portion 11b of the lower frame 11 is located above the upper surface of the opposing portion 11a, the outer shape of the remaining portion 11b is larger than the outer shape of the opposing portion 11a. By making the outer shape of the remaining portion 11b large in this manner, it is possible to increase the second moment of area of the remaining portion 11b. On the other hand, the thickness dimension T1 of the opposing portion 11a in the up-down direction is larger than the thickness dimension T2 of the remaining portion 11b in the up-down direction. By increasing the thickness of the opposing portion 11a in the up-down direction as described above, it is possible to increase the second moment of area of the opposing portion 11a.

(4) The opposing portion 11a has a solid structure, and the remaining portion 11b has a hollow structure.

According to the off-road vehicle 1 of the present embodiment, it is possible to increase strength against bending of each of the opposing portion 11a and the remaining portion 11b, and thus possible to suppress deformation of the lower frame 11.
(5) The lower frame 11 includes: the opposing member 60 constituting the opposing portion 11a; and the remaining member 70 constituting the remaining portion 11b, and the opposing member 60 and the remaining member 70 are joined to each other.

According to the off-road vehicle 1 of the present embodiment, it is possible to manufacture the lower frame 11 having portions with different dimensions in the up-down direction as compared with the case of manufacturing the lower frame 11 by cutting or molding.

(6) The opposing member 60 and the remaining member 70 are joined while being fitted to each other.

According to the off-road vehicle 1 of the present embodiment, it is possible to facilitate the work of joining the opposing member 60 and the remaining member 70, and possible to increase the strength of the joint portion 11c between the opposing member 60 and the remaining member 70. Since the work of joining the opposing member 60 and the remaining member 70 can be performed in a state where the opposing member 60 and the remaining member 70 are fitted and positioned with respect to each other, the joining work can be facilitated. In addition, since the opposing member 60 and the remaining member 70 are fitted to each other, it is possible to increase the strength of the joint portion 11c as compared with a configuration in which the opposing member 60 and the remaining member 70 are not fitted to each other.

(7) The opposing member 60 and the remaining member 70 are fitted to each other while the laterally projecting portion 62 formed in the opposing member 60 is inserted into the remaining member 70.

According to the off-road vehicle 1 of the present embodiment, since the opposing member 60 having a relatively small outer shape is inserted into the remaining member 70 having a relatively large outer shape, it is possible to suppress an increase in size of the lower frame 11.

(8) The opposing member 60 is a cast component or a forged component.

(9) The opposing member 60 is formed symmetrically with respect to the central plane CP including the central axis of the lower frame 11.

According to the off-road vehicle 1 of the present embodiment, in the configuration in which the opposing members 60 are arranged in the left-right direction, it is possible to standardize the opposing members 60.

(10) The body frame 10 further includes the vertical frame 12 disposed to extend in the up-down direction, and the opposing member 60 is joined to the vertical frame 12.

(11) The opposing member 60 and the vertical frame 12 are joined while being fitted to each other.

According to the off-road vehicle 1 of the present embodiment, it is possible to facilitate the work of joining the opposing member 60 and the vertical frame 12, and possible to increase the strength of the joint portion between the opposing member 60 and the vertical frame 12. Since the work of joining the opposing member 60 and the vertical frame 12 can be performed in a state where the opposing member 60 and the vertical frame 12 are fitted and positioned with respect to each other, the joining work can be facilitated. In addition, since the opposing member 60 and the vertical frame 12 are fitted to each other, it is possible to increase the strength of the joint portion as compared with a configuration in which the opposing member 60 and the vertical frame 12 are not fitted to each other.

(12) The opposing member 60 and the vertical frame 12 are fitted to each other while the vertically projecting portion 63 formed in the opposing member 60 is inserted into the vertical frame 12.

(13) The vehicle further includes the cover plate 50 that extends in the front-rear direction while covering at least the joint portion 11c between the opposing member 60 and the remaining member 70 of the lower frame 11 from below.

According to the off-road vehicle 1 of the present embodiment, since the cover plate 50 covers the joint portion 11c, it is possible to inhibit the joint portion 11c from interfering with an obstacle below the vehicle.

(14) The portion 50a of the cover plate 50 that covers the joint portion 11c is recessed downward as compared with the remaining portion 11b.

According to the off-road vehicle 1 of the present embodiment, the cover plate 50 can cover the joint portion 11c even when a portion (for example, the weld bead B1) protruding for joining is generated in the joint portion 11c between the remaining portion 11b and the opposing portion 11a.

(15) The cover plate 50 is joined to both the remaining portion 11b and the opposing portion 11a.

According to the off-road vehicle 1 of the present embodiment, it is possible to increase the joining strength between the cover plate 50 and the lower frame 11 as compared with a configuration in which the cover plate 50 is joined only to either the remaining portion 11b or the opposing portion 11a.

(16) The swing member includes the drive shaft 30 that transmits a rotational force to the rear wheel 20 and the link rod 41B that restricts movement of the rear wheel 20, and the opposing portion 11a is formed over a range opposed to both the drive shaft 30 and the link rod 41B.

According to the off-road vehicle 1 of the present embodiment, when the drive shaft 30 and the link rod 41B swing in the up-down direction, it is possible to inhibit the drive shaft 30 and the link rod 41B from coming into contact with the lower frame 11.

(17) The link rod 41B is curved upward at a position opposed to the lower frame 11.

According to the off-road vehicle 1 of the present embodiment, when the link rod 41B swings in the up-down direction, it is possible to inhibit the link rod 41B from coming into contact with the lower frame 11.

(18) The swing member has the pivot axis disposed inside the lower frame 11 in the vehicle width direction.

According to the off-road vehicle 1 of the present embodiment, the possibility that the swing member and the lower frame 11 interfere with each other is increased; however, by employing the above structure, it is possible to suppress interference between the swing member and the lower frame 11.

(19) The pair of left and right lower frames 11 is connected by the multiple cross members 13A, 13B.

According to the off-road vehicle 1 of the present embodiment, since the pair of left and right lower frames 11 is connected by the multiple cross members 13A, 13B, it is possible to prevent deformation of the lower frames 11. Accordingly, it is possible to suppress a decrease in rigidity of the lower frames 11 due to the formation of the recessed portion 61 in the opposing member 60.

(20) The pair of left and right lower frames 11 is connected by the multiple cross members 13A, 13B and the cover plate 50.

According to the off-road vehicle 1 of the present embodiment, since the pair of left and right lower frames 11 is connected by the multiple cross members 13A, 13B and the cover plate 50, it is possible to prevent deformation of the lower frames 11. Accordingly, it is possible to suppress a decrease in rigidity of the lower frames 11 due to the formation of the recessed portion 61 in the opposing member 60.

(21) The rod support portion 14 that supports the link rod 41A is attached to the contact portion 13a of the center cross member 13B that is in contact with the upper surface of the lower frame 11 from above.

According to the off-road vehicle 1 of the present embodiment, since the inner end portion in the vehicle width direction of the link rod 41A is disposed above the lower frame 11, it is not necessary to extend the recessed portion 61 forward in order to prevent interference between the lower frame 11 and the link rod 41A. As a result, it is possible to suppress an excessive decrease in rigidity of the lower frame 11.

(22) The center cross member 13B is formed by bending a plate, and the rod support portion 14 is formed integrally with the center cross member 13B.

According to the off-road vehicle 1 of the present embodiment, since the rod support portion 14 is formed integrally with the center cross member 13B, the rod support portion 14 can be fixed to the lower frame 11 by welding the center cross member 13B to the lower frame 11. As a result, the number of welded portions for fixing the rod support portion 14 can be reduced as compared with a configuration in which the rod support portion 14 and the center cross member 13B are separately welded to the lower frame 11.

(23) The opposing member 60 has the recessed portion 61 whose upper surface is recessed further downward than the upper surfaces of other portions of the opposing member 60.

According to the off-road vehicle 1 of the present embodiment, since the opposing member 60 has the recessed portion 61, interference between the link rod 41B and the lower frame 11 is suppressed, and thus, it is possible to lower the position in the vertical direction, that is, the height of the support position for supporting the inner end portion in the vehicle width direction of the link rod 41B. Accordingly, the height of the support position for supporting the inner end portion in the vehicle width direction of the link rod 41A and the height of the support position for supporting the inner end portion in the vehicle width direction of the link rod 41B can be brought close to each other. This makes it easy to synchronously operate the link rods 41A, 41B arranged in the front-rear direction, and thus possible to suppress a change in the toe direction of the rear wheel 20.

(24) The lower frame 11 has the inclined portion S2 extending inward in the vehicle width direction as extending rearward, and the link rod 41B and the drive shaft 30 are arranged above the inclined portion S2.

According to the off-road vehicle 1 of the present embodiment, the lower frame 11 has the parallel portion S1 extending in parallel with the front-rear direction, and it is possible to suppress interference between the swing member and the lower frame 11 as compared with a configuration in which the link rod 41B or the drive shaft 30 is disposed in the parallel portion S1. In addition, it is possible to increase the length of the link rod 41B and the drive shaft 30, and thus the amount of swing can be increased.

(25) The lower frame 11 includes the parallel portion S1 extending in parallel with the front-rear direction, and the off-road vehicle 1 includes the front cross member 13A that connects the parallel portions S1 of the pair of left and right lower frames 11 to each other.

According to the off-road vehicle 1 of the present embodiment, since the front cross member 13A is connected to the parallel portion S1 of the lower frame 11, the front cross member 13A is easily connected to the lower frame 11 as compared with a configuration in which the front cross member is connected to the inclined portion S2.

### Modified Example

The present disclosure is not limited to the configuration described in the above embodiment, and various modifications can be made.

In the above embodiment, the example in which the wheel according to the present disclosure is the rear wheel 20 has been described, but the wheel according to the present disclosure may be a front wheel.

In the above embodiment, the lower frame 11 has a divided structure including the opposing member 60 and the remaining member 70, but the lower frame according to the present disclosure may have an integrated structure. The opposing portion and the remaining portion according to the present disclosure may be formed as an integrated structural part.

The off-road vehicle according to the present disclosure may include one-row seats or two-row seats.

As a drive source, the off-road vehicle according to the present disclosure may have an engine, may have an electric motor, or may have both the engine and the electric motor.

The off-road vehicle according to the present disclosure may be two-wheel drive or four-wheel drive. The off-road vehicle according to the present disclosure may have a switching function between two-wheel drive and four-wheel drive or may have no such a switching function.

The off-road vehicle according to the present disclosure may have a lock function of the differential mechanism or may have no such a lock function.

In the above embodiment, three members, that is, the shaft body 31, the inner cover 32A, and the link rod 41B are exemplified as the swing member to be prevented from interfering with the lower frame 11, but the swing member according to the present disclosure is not limited thereto. A structure having an opposing portion for at least one of the three is also included in the present disclosure. In addition, the present disclosure also includes a structure in which opposing portions are formed for other swing members other than the three swing members described above.

In the above embodiment, the lower frame 11 includes the multiple members including the opposing member 60 and the remaining member 70, but the lower frame may be implemented by one member.

In the above embodiment, the opposing member 60 is implemented by a die-formed member, but may be implemented by a machined member.

In the above embodiment, the remaining member 70 is disposed only in front of the opposing member 60, but the remaining member 70 may also be disposed behind the opposing member 60.

In the above embodiment, the opposing member 60 and the remaining member 70 are joined to each other by welding, but may be joined to each other by a joining method other than welding such as bolt fastening.

In the above embodiment, the opposing member 60 is inserted into the remaining member 70 and the vertical frame 12, but the opposite configuration may be employed. In other words, the remaining member 70 may be inserted into the opposing member 60, or the vertical frame 12 may be inserted into the opposing member 60. The rear end of the remaining member 70 may have a shape different from that of the remaining portion 11b in order to be fitted to the opposing member 60.

In the above embodiment, the opposing portion 11a is solid, but may be hollow. In this case, the thickness thereof is preferably larger than that of the remaining portion 11b.

In the above embodiment, the front cross member 13A and the center cross member 13B are arranged between the pair of left and right lower frames 11, but a rear cross member connecting the rear ends of the pair of lower frames 11 may be interposed between the pair of lower frames 11.

The cover plate 50 does not necessarily have to completely cover the lower portion of the lower frame 11. An opening penetrating in the up-down direction may be formed in the cover plate 50.

Another member may be provided below the cover plate 50 or the lower frame 11.

The number of link rods 41 is not limited to three. The arrangement of the link rods 41 may be another arrangement. For example, the link rod 41A may be omitted.

A bracket structure for supporting the link rod 41A may be formed on the opposing member 60. In this case, the bracket structure for supporting the link rod 41A may be formed to have the same diameter as the remaining member 70.

In the above embodiment, the lower surface of the opposing portion 11a extends along the lower surface of the remaining portion 11b, but a configuration in which the lower surface of the opposing portion 11a does not extend along the lower surface of the remaining portion 11b is also included in the present disclosure.

### Supplementary Note

The off-road vehicle according to the present disclosure provides the following aspects.

### Aspect 1

An off-road vehicle including:
a body frame;
a wheel that is disposed outside the body frame in a vehicle width direction; and
a swing member that has one end mechanically connected to the wheel, extends in the vehicle width direction, and is disposed so as to be vertically swingable with respect to the body frame, in which
the body frame includes a lower frame that is disposed below the swing member while extending in a front-rear direction, and
an upper surface of an opposing portion of the lower frame opposed to the swing member in an up-down direction is recessed downward as compared with an upper surface of a remaining portion excluding the opposing portion, and a lower surface of the opposing portion extends along a lower surface of the remaining portion.

### Aspect 2

The off-road vehicle according to Aspect 1, in which the lower surface of the opposing portion extends along the lower surface of the remaining portion.

### Aspect 3

The off-road vehicle according to Aspect 1 or 2, in which a thickness dimension of the opposing portion in the up-down direction is larger than a thickness dimension of the remaining portion in the up-down direction.

### Aspect 4

The off-road vehicle according to any one of Aspects 1 to 3, in which
the opposing portion has a solid structure, and
the remaining portion has a hollow structure.

### Aspect 5

The off-road vehicle according to any one of Aspects 1 to 4, in which
the lower frame includes:
an opposing member constituting the opposing portion; and
a remaining member constituting the remaining portion, and
the opposing member and the remaining member are joined to each other.

### Aspect 6

The off-road vehicle according to Aspect 5, in which the opposing member and the remaining member are joined while being fitted to each other.

### Aspect 7

The off-road vehicle according to Aspect 5 or 6, in which the opposing member and the remaining member are fitted to each other while a laterally projecting portion formed in the opposing member is inserted into the remaining member.

### Aspect 8

The off-road vehicle according to any one of Aspects 5 to 7, in which the opposing member is any of a cast component and a forged component.

### Aspect 9

The off-road vehicle according to any one of Aspects 4 to 8, in which the opposing member is formed symmetrically with respect to a central plane including a central axis of the lower frame.

### Aspect 10

The off-road vehicle according to any one of Aspects 5 to 9, in which
the body frame further includes a vertical frame disposed to extend in the up-down direction, and
the opposing member is joined to the vertical frame.

### Aspect 11

The off-road vehicle according to Aspect 10, in which the opposing member and the vertical frame are joined while being fitted to each other.

### Aspect 12

The off-road vehicle according to Aspect 10 or 11, in which the opposing member and the vertical frame are fitted to each other while a vertically projecting portion formed in the opposing member is inserted into the vertical frame.

### Aspect 13

The off-road vehicle according to any one of Aspects 5 to 13, further including a cover plate that extends in the front-rear direction while covering at least a joint portion between the opposing member and the remaining member of the lower frame from below.

### Aspect 14

The off-road vehicle according to Aspect 13, in which a portion of the cover plate that covers the joint portion is recessed downward as compared with the remaining portion.

### Aspect 15

The off-road vehicle according to Aspect 13 or 14, in which the cover plate is joined to both the remaining portion and the opposing portion.

### Aspect 16

The off-road vehicle according to any one of Aspects 1 to 15, in which
the swing member includes:
a drive shaft that transmits a rotational force to the wheel; and
a link arm that restricts movement of the wheel, and
the opposing portion is formed over a range opposed to both the drive shaft and the link arm.

### Aspect 17

The off-road vehicle according to any one of Aspects 1 to 16, in which the swing member is curved upward at a position opposed to the lower frame.

### Aspect 18

The off-road vehicle according to any one of Aspects 1 to 17, in which the swing member has a pivot axis disposed inside the lower frame in the vehicle width direction.

What is claimed is

1. An off-road vehicle comprising:
a body frame;
a wheel that is disposed outside the body frame in a vehicle width direction; and
a swing member that has one end mechanically connected to the wheel, extends in the vehicle width direction, and is disposed so as to be vertically swingable with respect to the body frame, wherein
the body frame includes a lower frame that is disposed below the swing member while extending in a front-rear direction, and
an upper surface of an opposing portion of the lower frame opposed to the swing member in an up-down direction is recessed downward as compared with an upper surface of a remaining portion excluding the opposing portion.

2. The off-road vehicle according to claim 1, wherein a lower surface of the opposing portion extends along a lower surface of the remaining portion.

3. The off-road vehicle according to claim 1, wherein a thickness dimension of the opposing portion in the up-down direction is larger than a thickness dimension of the remaining portion in the up-down direction.

4. The off-road vehicle according to claim 3, wherein
the opposing portion has a solid structure, and
the remaining portion has a hollow structure.

5. The off-road vehicle according to claim 1, wherein
the lower frame includes:
an opposing member constituting the opposing portion; and
a remaining member constituting the remaining portion, and
the opposing member and the remaining member are joined to each other.

6. The off-road vehicle according to claim 5, wherein the opposing member and the remaining member are joined while being fitted to each other.

7. The off-road vehicle according to claim 6, wherein the opposing member and the remaining member are fitted to each other while a laterally projecting portion formed in the opposing member is inserted into the remaining member.

8. The off-road vehicle according to claim 5, wherein the opposing member is any of a cast component and a forged component.

9. The off-road vehicle according to claim 5, wherein the opposing member is formed symmetrically with respect to a central plane including a central axis of the lower frame.

10. The off-road vehicle according to claim 5, wherein
the body frame further includes a vertical frame disposed to extend in the up-down direction, and
the opposing member is joined to the vertical frame.

11. The off-road vehicle according to claim 10, wherein the opposing member and the vertical frame are joined while being fitted to each other.

12. The off-road vehicle according to claim 11, wherein the opposing member and the vertical frame are fitted to each other while a vertically projecting portion formed in the opposing member is inserted into the vertical frame.

13. The off-road vehicle according to claim 5, further comprising a cover plate that extends in the front-rear direction while covering at least a joint portion between the opposing member and the remaining member of the lower frame from below.

14. The off-road vehicle according to claim 13, wherein a portion of the cover plate that covers the joint portion is recessed downward as compared with the remaining portion.

15. The off-road vehicle according to claim 13, wherein the cover plate is joined to both the remaining portion and the opposing portion.

16. The off-road vehicle according to claim 1, wherein
the swing member includes:
a drive shaft that transmits a rotational force to the wheel; and
a link arm that restricts movement of the wheel, and
the opposing portion is formed over a range opposed to both the drive shaft and the link arm.

17. The off-road vehicle according to claim 1, wherein the swing member is curved upward at a position opposed to the lower frame.

18. The off-road vehicle according to claim 1, wherein the swing member has a pivot axis disposed inside the lower frame in the vehicle width direction.
